(19) United States
(12) Patent Application Publication
(10) Pub. No.: US 2025/0308753 A1
(43) Pub. Date: Oct. 2, 2025

(54) TRANSFORMER UNIT AND TRANSFORMER ASSEMBLY

(71) Applicant: Murata Manufacturing Co., Ltd., Nagaokakyo-shi (JP)

(72) Inventors: Hongzhong MA, Dongguan City (CN); Dan JIANG, Dongguan City (CN); Zhuoliang HUANG, Dongguan City (CN)

(21) Appl. No.: 19/090,622

(22) Filed: Mar. 26, 2025

(30) Foreign Application Priority Data
Mar. 28, 2024 (CN) 202410374064.1

(51) Int. Cl. H01F 27/28

(52) U.S. Cl. CPC H01F 27/2847; H01F 27/2895

(57) ABSTRACT

A transformer unit includes a base plate and a cover plate, a first magnetic column and second magnetic columns between the base plate and the cover plate. The second magnetic columns are arranged around the first magnetic column in a first plane that is parallel or substantially parallel to the base plate, a secondary winding wound around the first magnetic column, and primary windings with a one-to-one correspondence with the second magnetic columns, wherein each of the primary windings is wound around a corresponding second magnetic column.

### CROSS-REFERENCE TO RELATED APPLICATIONS

The present application claims priority to Chinese patent application No. 202410374064.1, filed on Mar. 28, 2024, and the entire contents of which are incorporated herein by reference.

### BACKGROUND OF THE INVENTION

### 1. Field of the Invention

The present disclosure generally relates to transformer technologies, and more particularly, to transformer units and transformer assemblies.

### 2. Description of the Related Art

Trans-inductor voltage regulator (TLVR) inductors are high-current transformers s that can achieve fast multi-phase voltage regulation, and are becoming more and more widely used due to quick response and low cost.

At present, a transformer used in a TLVR topology structure generally includes primary coils, secondary coils and two magnetic cores. The primary coils and the secondary coils are arranged between the two magnetic cores and wound together around a same magnetic column, and the primary coils are sleeved outside the secondary coils.

In existing solutions, the primary windings and the secondary windings have a one-to-one correspondence, and the number of the primary coils is equal to the number of the secondary coils. To achieve a quick response of a TLVR circuit, multiple transformers need to work simultaneously, where primary windings of the multiple transformers are connected in parallel, and secondary windings of the multiple transformers are connected in series. However, the increase in the number of the secondary windings will increase manufacturing costs and assembly difficulty of the transformers, and also affect efficiency of the transformers (e.g., operation efficiency).

### SUMMARY OF THE INVENTION

Example embodiments of the present invention provide improved transformer units and transformer assemblies, each of which reduce manufacturing costs and assembly difficulty of transformers and improve efficiency of the transformers.

An example embodiment of the present invention provides a transformer unit including a base plate and a cover plate, a first magnetic column and a plurality of second magnetic columns between the base plate and the cover plate, a secondary winding wound around the first magnetic column, and a plurality of primary windings with a one-to-one correspondence with the plurality of second magnetic columns, wherein the plurality of second magnetic columns are provided around the first magnetic column in a first plane that is parallel or substantially parallel to the base plate, and each of the plurality of primary windings is wound around a corresponding second magnetic column.

A distance between each of the plurality of second magnetic columns and the first magnetic column may be equal or substantially equal.

Projections of the plurality of primary windings on the first plane may not overlap with each other.

The plurality of second magnetic columns may include a first column and a second column arranged along a first direction, and the first magnetic column may be between the first column and the second column along the first direction, where the first direction is parallel or substantially parallel to the first plane.

The plurality of second magnetic columns may include a first column, a second column, and a third column that define a closed or partially closed structure around the first magnetic column in the first plane.

The first magnetic column may be surrounded by the first column, the second column, and the third column which define a ring.

A region enclosed by projections of the first column, the second column, and the third column on the first plane may have a T-shape, and a projection of the first magnetic column on the first plane may be located at an intersection of a horizontal side and a vertical side of the T-shape.

For each of the first magnetic column and the plurality of second magnetic columns, an air gap may be provided on the magnetic column, and/or an air gap may be provided between the magnetic column and the base plate and/or the cover plate.

For each of the plurality of primary windings and the secondary winding, the winding may include a main body including a notch, and for each of the first magnetic column and the plurality of second magnetic columns, the magnetic column may extend from the notch into the corresponding main body in the first plane.

In the first plane, an orientation of the notch on at least one main body may be different from an orientation of the notches on other main bodies.

The base plate, the cover plate, the first magnetic column and the plurality of second magnetic columns may be integrally provided.

For each of the plurality of primary windings and the secondary winding, the winding may include a conductive strip wound in a cylindrical shape.

A thickness of the conductive strip of the primary windings may be greater than a thickness of the conductive strip of the secondary winding.

For any one of the first magnetic column and the plurality of second magnetic columns, the conductive strip may surround at least three quarters of an outer circumference of the magnetic column in the first plane.

For each of the plurality of primary windings and the secondary winding, the winding may include a wing portion extending in a direction away from the transformer unit, and the wing portion may define a support and an electrical connection end.

An example embodiment of the present invention provides a transformer assembly including a plurality of transformer units according to an example embodiment of the present invention, where a separation magnetic core is provided between adjacent transformer units.

The cover plate of one of the adjacent transformer units may define and function as the base plate of the other of the adjacent transformer units.

The plurality of transformer units may be arranged along a second direction that is perpendicular or substantially perpendicular to the first plane.

Example embodiments of the present invention provide the following advantages.

An example embodiment of the present invention provides a transformer unit including a base plate and a cover plate, a first magnetic column and a plurality of second magnetic columns between the base plate and the cover plate, a secondary winding wound around the first magnetic column, and a plurality of primary windings with a one-to-one correspondence with the plurality of second magnetic columns, wherein the plurality of second magnetic columns are provided around the first magnetic column in a first plane that is parallel or substantially parallel to the base plate, and each of the plurality of primary windings is wound around a corresponding second magnetic column.

Compared with the existing solutions where the primary windings and the secondary windings of the transformers have a one-to-one correspondence, an example embodiment of the present invention reduces the number of secondary windings by setting multiple primary windings to correspond to a same secondary winding in a single transformer unit, thus reducing costs and assembly difficulty, and improving efficiency of a transformer while ensuring device miniaturization. Further, multiple primary windings are integrated together to share a magnetic core, which reduces magnetic core losses.

Further, a plurality of non-overlapping primary windings are arranged in a same plane, and the secondary winding is arranged among the plurality of primary windings, which reduces assembly difficulty and improves operation efficiency of the transformer while maintaining overall miniaturization of a device.

Further, an air gap is provided on the magnetic column and/or between the magnetic column and the base plate and/or the cover plate, so that coupling between the primary windings is reduced, inductance is adjusted, and a saturation current is increased.

An example embodiment of the present invention provides a transformer assembly, including a plurality of transformer units according to an example embodiment of the present invention, wherein a separation magnetic core is provided between adjacent transformer units.

With this example embodiment, multiple transformer units with a “multi-to-one” structure are integrated to obtain the transformer assembly, which further improves the operation efficiency of the transformer, and reduces an overall volume and manufacturing costs of the transformer assembly. Specifically, the “multi-to-one” structure refers to that multiple primary windings correspond to the same secondary winding in a single transformer unit.

Further, each transformer unit in the transformer assembly includes multiple primary windings, and the number of the secondary windings is significantly smaller than the number of the primary windings, which means that an increase in the number of the primary windings in the transformer assembly will not cause an increase in the number of the secondary windings, and thus will not be limited by factors such as losses, costs, and manufacturing difficulty. Therefore, in an application scenario of a TLVR circuit, an example embodiment of the transformer assembly better satisfies the requirements of quick response of the TLVR circuit with a smaller size.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram of a transformer unit according to an example embodiment of the present invention.

FIG. 2 is an exploded view of the transformer unit in

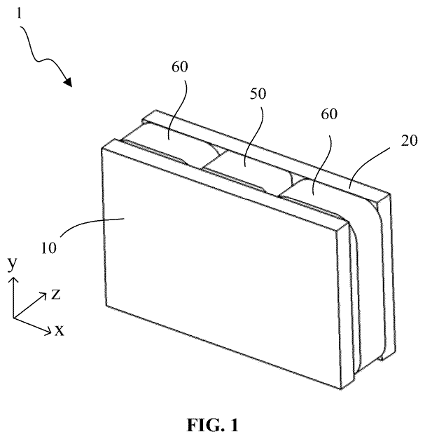

FIG. 1.

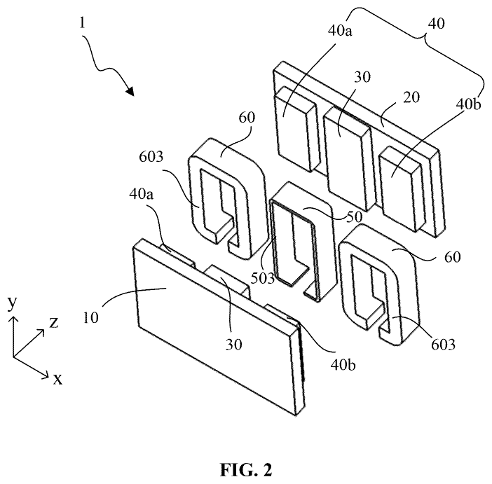

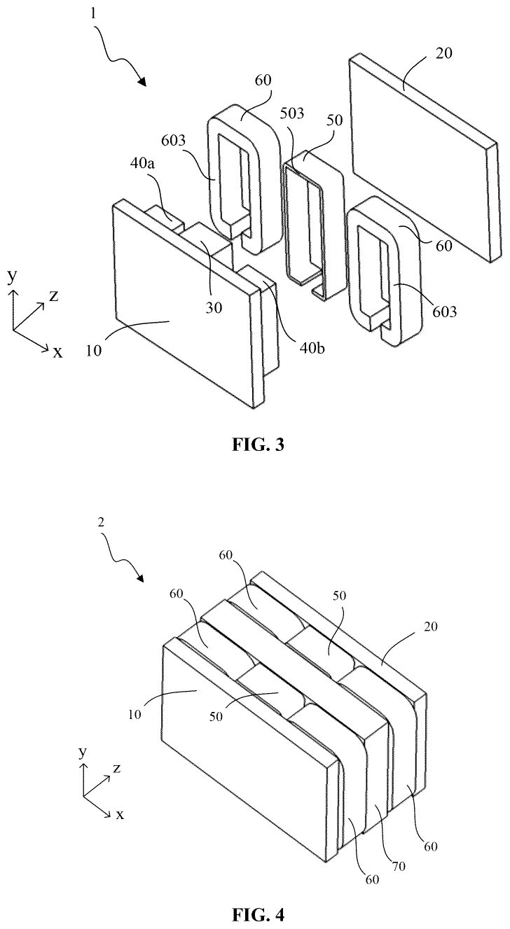

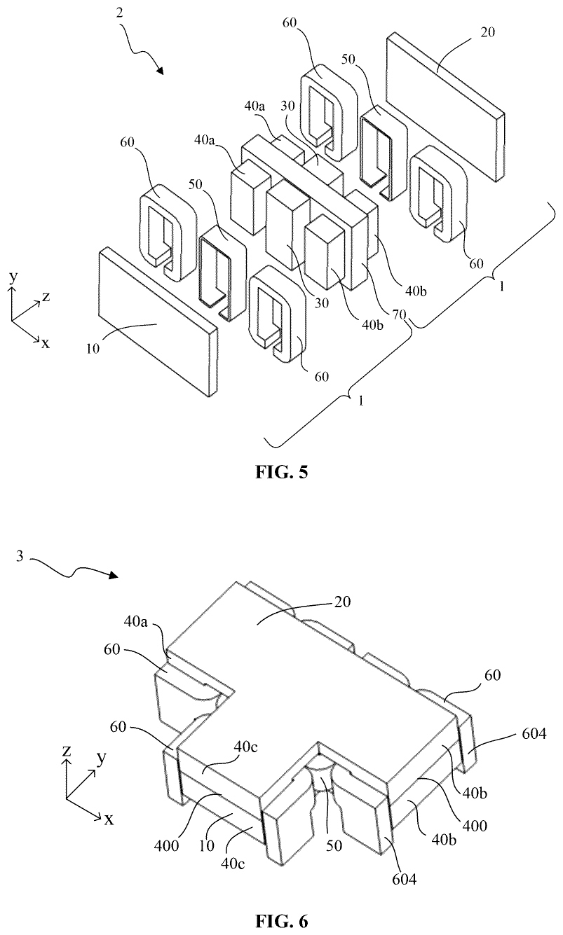

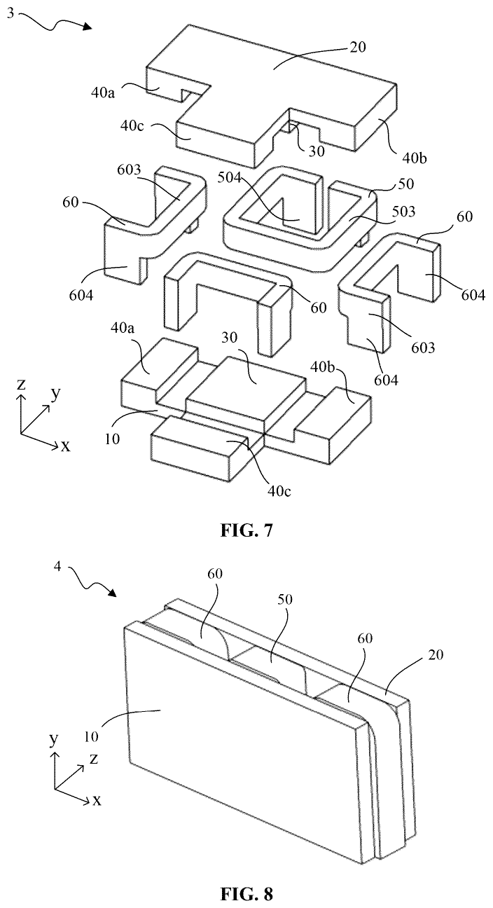

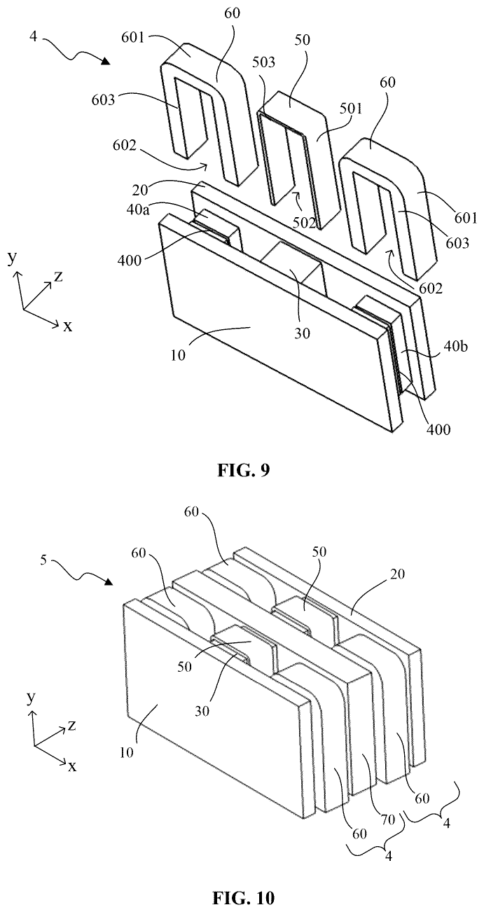

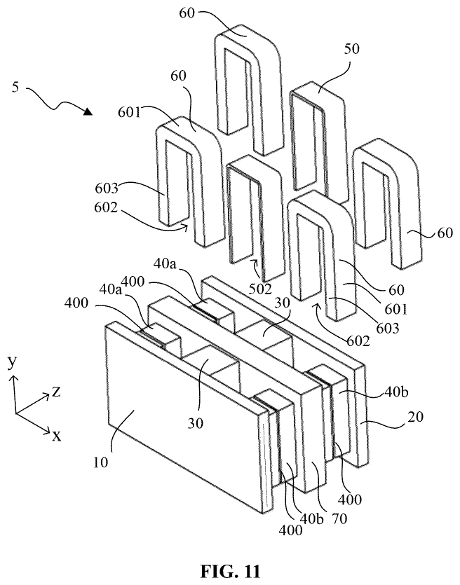

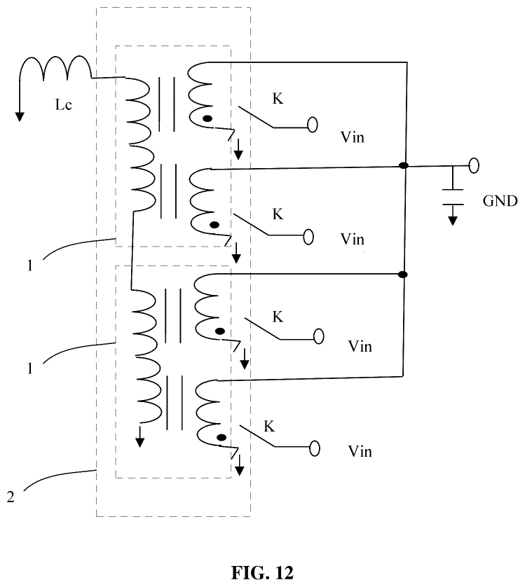

FIG. 3 is an exploded view of a variation of the transformer unit shown in FIG. 2.

FIG. 4 is a schematic diagram of a transformer assembly according to an example embodiment of the present invention.

FIG. 5 is an exploded view of the transformer assembly in FIG. 4.

FIG. 6 is a schematic diagram of a transformer unit according to an example embodiment of the present invention.

FIG. 7 is an exploded view of the transformer unit in FIG. 6.

FIG. 8 is a schematic diagram of a transformer unit according to an example embodiment of the present invention.

FIG. 9 is an exploded view of the transformer unit in FIG. 8.

FIG. 10 is a schematic diagram of a transformer assembly according to an example embodiment of the present invention.

FIG. 11 is an exploded view of the transformer assembly in FIG. 10.

FIG. 12 is a circuit schematic diagram of a typical application scenario according to an example embodiment of the present invention.

### DETAILED DESCRIPTION OF THE EXAMPLE EMBODIMENTS

As described in the background, the existing solutions that the primary windings and the secondary windings of the transformers have a one-to-one correspondence cannot adapt to application scenarios such as TLVR circuits that have high requirements for quick response.

The inventors of example embodiments of the present invention have discovered through analysis that one of the reasons for the above problem is that the primary windings and the secondary windings in the existing transformers are arranged in a one-to-one correspondence. If the number of the primary windings is to be increased, the corresponding number of secondary windings must be increased. However, the increase in the number of the secondary windings will increase manufacturing costs and assembly difficulty of the transformers, and also adversely affect the efficiency of the transformers.

An example embodiment of the present invention provides a transformer unit including a base plate and a cover plate, a first magnetic column and a plurality of second magnetic columns between the base plate and the cover plate, a secondary winding wound around the first magnetic column, and a plurality of primary windings with a one-to-one correspondence with the plurality of second magnetic columns, wherein the plurality of second magnetic columns are arranged around the first magnetic column in a first plane that is parallel or substantially parallel to the base plate, and each of the plurality of primary windings is wound around a corresponding second magnetic column.

Compared with the existing solutions where the primary windings and the secondary windings of the transformers have a one-to-one correspondence, example embodiments of the present invention reduce the number of secondary windings by setting multiple primary windings to correspond to a same secondary winding in a single transformer unit, thus reducing costs and assembly difficulty, and improving efficiency of a transformer while ensuring device miniaturization. Further, multiple primary windings are integrated together to share a magnetic core, which reduces losses of the magnetic core.

Hereinafter, example embodiments of the present disclosure are described in detail with reference to drawings. In each figure, the same portion is labeled with the same reference character. Each example embodiment is only a non-limiting example, and it is possible to partially replace or combine structures shown in different example embodiments. In modified examples, description of matters common to a foregoing example embodiment is omitted, and only differences are described. In particular, the same advantageous effects produced by the same structure is not repeated in each example embodiment.

In order to make the above features and advantageous effects of the present invention more obvious and understandable, specific example embodiments of the present invention will be described in detail below with reference to the accompanying drawings.

FIG. 1 is a schematic diagram of a transformer unit 1 according to an example embodiment of the present invention, and FIG. 2 is an exploded view of the transformer unit 1 shown in FIG. 1.

Specifically, referring to FIG. 1 and FIG. 2, the transformer unit 1 includes a base plate 10 and a cover plate 20. For each transformer unit 1, the base plate 10 and the cover plate 20 may be parallel or substantially parallel to each other.

Further, still referring to FIG. 2, the transformer unit 1 may include a first magnetic column 30 and a plurality of (e.g., n) second magnetic columns 40, which are arranged between the base plate 10 and the cover plate 20. The n second magnetic columns 40 are arranged around the first magnetic column 30 in a first plane. The first plane is parallel or substantially parallel to the base plate 10, and n≥2.

The base plate 10, the cover plate 20, the first magnetic column 30, and the second magnetic columns 40 may be made of a magnetic core material such as, for example, manganese-zinc ferrite or nickel-zinc ferrite to increase magnetic induction intensity of the transformer unit 1.

The transformer unit 1 may have a length direction (x direction in the figures), a width direction (y direction in the figures) and a height direction (z direction in the figures) which are perpendicular or substantially perpendicular to each other. The height direction (the z direction in the figures) is defined by a direction (i.e., an axial direction of the first magnetic column 30) in which the base plate 10 points to the cover plate 20. On a plane perpendicular or substantially perpendicular to the z direction, two adjacent sides of the base plate 10 respectively define the length direction (the x direction in the figures) and the width direction (the y direction in the figures). The first plane may be a plane defined by the x direction and the y direction.

Further, still referring to FIG. 2, the first magnetic column 30 may be divided into two portions along the z direction, and the two portions are connected to the base plate 10 and the cover plate 20 respectively. Similarly, each second magnetic column 40 may also be divided into two portions along the z direction, and the two portions are connected to the base plate 10 and the cover plate 20 respectively.

According to the perspective shown in FIG. 2, an upper portion of the first magnetic column 30 along the z direction and an upper portion of each second magnetic column 40 along the z direction may be integrally provided with the cover plate 20, and a lower portion of the first magnetic column 30 along the z direction and a lower portion of each second magnetic column 40 along the z direction may be integrally provided with the base plate 10, so as to respectively form magnetic core structures with an approximately E-shape. In other words, one of the two E-shaped magnetic core structures includes the upper portion of the first magnetic column 30, the upper portion of each second magnetic column 40, and the cover plate 20, and the other of the two E-shaped magnetic core structures includes the lower portion of the first magnetic column 30, the lower portion of each second magnetic column 40, and the base plate 10.

Alternatively, the upper portion of the first magnetic column 30 and the upper portion of each second magnetic column 40 along the z direction may be bonded together with the cover plate 20 during assembly. Similarly, the lower portion of the first magnetic column 30 and the lower portion of each second magnetic column 40 along the z direction may be bonded together with the base plate 10 during assembly. For each of the first magnetic column 30 and the second magnetic columns 40, lengths of the two portions obtained by dividing the magnetic column along the z direction may be the same or different.

Further, the transformer unit 1 may also include a secondary winding 50 wound around the first magnetic column 30, and a plurality of (denoted as n) primary windings 60. The n primary windings 60 and the n second magnetic columns 40 have a one-to-one correspondence, and each primary winding 60 is wound around the corresponding second magnetic column 40.

Further, in the plane defined by the x direction and the y direction, cross-sections of the base plate 10 and the cover plate 20 may be rectangular or substantially rectangular structures with the same or substantially the same areas, such as squares or rectangles. In practical applications, those skilled in the art may adjust shapes of the base plate 10 and the cover plate 20 as needed to obtain magnetic induction effects that meets requirements.

The example embodiment in FIG. 1 and FIG. 2 is exemplarily illustrated by taking n=2 as an example. Specifically, the transformer unit 1 includes the base plate 10 and the cover plate 20 arranged along the height direction (the z direction in the figures), and the first magnetic column 30 and two second magnetic columns 40 are arranged between the base plate 10 and the cover plate 20. For the convenience of distinction, the two second magnetic columns 40 are respectively denoted as a first column 40a and a second column 40b.

Further, in the first plane parallel or substantially parallel to the base plate 10, the first column 40a and the second column 40b may be arranged along a first direction, and the first magnetic column 30 is disposed between the first column 40a and the second column 40b along the first direction. The first direction may be parallel or substantially parallel to the first plane. In some example embodiments, the first direction may be, for example, the length direction (the x direction shown in the figures). Alternatively, the first direction may be, for example, the y direction, or the first direction may be parallel or substantially parallel to the first plane and have a non-zero angle with the x direction and the y direction, respectively.

Further, a distance from each of the plurality of second magnetic columns 40 to the first magnetic column 30 may be equal or substantially equal. For example, referring to FIG. 2, the distance from the first column 40a to the first magnetic column 30 is equal or substantially equal to the distance from the second column 40b to the first magnetic column 30. In some example embodiments, being substantially equal may mean that an error of the distance from each second magnetic column 40 to the first magnetic column 30 is within a preset tolerance range which refers to a tolerance range of size. The error may be caused by an assembly process error during a manufacturing process.

Further, on the plane defined by the x direction and the y direction, cross-sections of the first magnetic column 30, the first column 40a and the second column 40b may all be rectangular or substantially rectangular, but are not limited thereto, and may be circular, substantially circular, elliptical, or substantially elliptical.

Further, in some example embodiments, the number of the primary windings 60 may be 2, for example. The two primary windings 60 are respectively wound around the first column 40a and the second column 40b.

Further, projections of the primary windings 60 on the first plane may not overlap. For example, referring to FIG. 1 and FIG. 2, the projections of the two primary windings 60 on the first plane (e.g., the base plate 10 or the cover plate 20) do not overlap.

Further, for each of the first magnetic column 30 and the plurality of second magnetic columns 40, an air gap (not shown) may be provided on the magnetic column to prevent the transformer unit 1 from generating magnetic saturation during operation. In some example embodiments, the air gap may be located at any position of the magnetic column.

For example, referring to FIG. 2, an air gap may be provided between the upper and lower portions of the first magnetic column 30 along the z direction. Similarly, an air gap may be provided between the upper and lower portions of the first column 40a and the second column 40b respectively along the z direction.

In some example embodiments, referring to FIG. 2, two E-shaped magnetic cores may be bonded together using glue with glass beads to provide an air gap in the middle of each magnetic column.

In some example embodiments, there may be an air gap between the magnetic column and the base plate 10 and/or the cover plate 20. For example, the air gap may be provided at a joint between the first magnetic column 30 and the cover plate 20, a joint between the first magnetic column 30 and the base plate 20, a joint between the plurality of second magnetic columns 40 and the cover plate 20, and/or a joint between the plurality of second magnetic columns 40 and the base plate 10.

Further, the secondary winding 50 may include a conductive strip 503 wound in a cylindrical shape. The first magnetic column 30 is accommodated in a hollow portion of the cylindrical shape.

Further, the two primary windings 60 may respectively include a conductive strip 603 wound into a cylindrical shape. The second magnetic columns 40 pass through hollow portions of the cylindrical shape along the z direction.

Further, the conductive strip 503 and the conductive strips 603 may be formed by, for example, bending tinned copper.

Further, a thickness of the conductive strip 603 of each primary winding 60 may be greater than a thickness of the conductive strip 503 used for the secondary winding 50. Therefore, the primary winding 60 can adapt to a higher operation current, which is beneficial to improving coupling effects of the transformer unit 1.

Further, along the z direction, a total height of the first magnetic column 30 with the secondary winding 50 wound may be equal or substantially equal to a total height of the second magnetic column 40 with the corresponding primary winding 60 wound. Therefore, an overall shape of the transformer unit 1 is more square, which is conducive to reducing difficulty of welding on a circuit board.

Further, the conductive strip 503 may surround at least three quarters of an outer circumference of the first magnetic column 30 in the first plane. For example, referring to FIG. 2, the conductive strip 503 almost completely surrounds the first magnetic column 30 in the first plane, and retains a small gap at a starting end and an ending end of the winding, so as to provide a current input terminal and a current output terminal at the starting end and the ending end, respectively.

Further, the two conductive strips 603 respectively surround at least three quarters of outer circumferences of the plurality of second magnetic columns 40 in the first plane. For example, referring to FIG. 2, the two conductive strips 603 almost completely surround the first column 40a and the second column 40b in the first plane, respectively, and retain small gaps at starting ends and ending ends of the windings, so as to provide current input terminals and current output terminals at the starting ends and the ending ends, respectively.

Further, cross-sectional areas of a portion of the secondary winding 50 surrounded by the conductive strip 503 in the first plane may be no less than a cross-sectional area of each primary winding 60 surrounded by the corresponding conductive strip 603 in the first plane. For example, still referring to FIG. 2, a height of the first magnetic column 30 along the y direction may be greater than a height of each second magnetic column 40 along the y direction, so as to ensure that the cross-sectional area of the secondary winding 50 in the first plane is larger after winding, thus reducing magnetic flux density in the first plane.

Therefore, the above example embodiment can reduce the number of the secondary windings 50, thus reducing costs and assembly difficulty, and improving efficiency of transformers while ensuring device miniaturization. Further, the two primary windings 60 are integrated together to share a magnetic core, which reduces losses of the magnetic core.

Further, as each magnetic column is divided into two portions and an air gap is provided on the magnetic column, inductance can be adjusted and a saturation current is increased by reducing coupling between the primary windings 60.

Further, a plurality of non-overlapping primary windings 60 are arranged in a same plane, and the secondary winding 50 is arranged among the plurality of non-overlapping primary windings 60, which reduces assembly difficulty and improves efficiency of the transformer while maintaining the overall miniaturization of a device.

In a variation of the example embodiment shown in FIG. 2, referring to FIG. 3, one first magnetic column 30 and two second magnetic columns 40 are disposed between the base plate 10 and the cover plate 20. For the convenience of distinction, the two second magnetic columns 40 are respectively denoted as the first column 40a and the second column 40b.

In the present variation, the first magnetic column 30, the first column 40a, and the second column 40b may each be an entirety and respectively connected to the base plate 10.

In the above example embodiment shown in FIG. 2, each of the first magnetic column 30, the first column 40a, and the second column 40b is connected to the base plate 10 and the cover plate 20 along the z direction, thus providing two E-shaped magnetic cores arranged opposite to each other along the z direction. However, in the present variation, the first magnetic column 30, the first column 40a, and the second column 40b are all entire components and are connected to the base plate 10, respectively, thus providing an I-shaped magnetic core and an E-shaped magnetic core. In other words, the E-shaped magnetic core structure includes the first magnetic column 30, the first column 40a, the second column 40b, and the base plate 10, and the I-shaped magnetic core includes the cover plate 20.

Further, the first magnetic column 30, the second magnetic column 40, and the base plate 10 may be an integral portion.

Further, for each of the first magnetic column 30, the first column 40a, and the second column 40b, an air gap may be provided between the magnetic column and the cover plate 20.

In another variation of the example embodiment shown in FIG. 2, the first magnetic column 30 and the two second magnetic columns 40 may each be an entirety and respectively connected to the cover plate 20.

Further, for each of the first magnetic column 30, the first column 40a, and the second column 40b, an air gap may be provided between the magnetic column and the base plate 10.

Therefore, the arrangement of the E-shaped magnetic core and the I-shaped magnetic core facilitates the production and assembly of the transformer unit 1.

FIG. 4 is a schematic diagram of a transformer assembly 2 according to an example embodiment of the present invention, and FIG. 5 is an exploded diagram of the transformer assembly 2 shown in FIG. 4.

Specifically, the transformer assembly 2 may include a plurality of above transformer units 1 described in the example embodiment shown in FIG. 1 to FIG. 3.

FIG. 4 and FIG. 5 exemplarily illustrate the transformer assembly 2 including two transformer units 1 shown in FIG. 3. Specifically, the two transformer units 1 are arranged side by side along the height direction (the z direction in the figures).

A specific structure of the transformer unit 1 is provided in the relevant description of the above example embodiments shown in FIG. 1 to FIG. 3, and is not repeated here.

Further, the plurality of transformer units 1 may be arranged along a second direction that is perpendicular or substantially perpendicular to the first plane. For example, referring to FIG. 4 and FIG. 5, the two transformer units 1 are arranged along the z direction.

Further, central axes of the plurality of transformer units 1 along the second direction (e.g., the z direction) may overlap.

Further, a separation magnetic core 70 may be provided between adjacent transformer units 1.

Further, the separation magnetic core 70 may include a base plate 10 or a cover plate 20 shared by the adjacent transformer units 1. For example, referring to FIG. 5, the cover plate 20 of one of the adjacent transformer units 1 may define and function as the base plate 10 of the other of the adjacent transformer units 1, which further reduces a length of the transformer assembly 2 along the z direction to provide a compact design.

Further, the first magnetic column 30, the first column 40a, and the second column 40b of each of the two transformer units 1 may be an entirety. The two entireties are respectively disposed on two surfaces of the separation magnetic core 70 along the height direction (the z direction in the figure).

Further, for each of the first magnetic column 30, the first column 40a, and the second column 40b, an air gap (not shown) may be provided between the magnetic column and the base plate 10 or the cover plate 20 opposite to the separation magnetic core 70 along the z direction.

In a variation of the example embodiment shown in FIG. 4 and FIG. 5, the first magnetic column 30, the first column 40a, and the second column 40b of each of the two transformer units 1 may be an entirety, and the two entireties are respectively arranged on the base plate 10 or the cover plate 20 opposite to the separation magnetic core 70 along the z direction.

Further, for each of the first magnetic column 30, the first column 40a, and the second column 40b, an air gap may be provided between the magnetic column and a surface of the separation magnetic core 70 which faces the magnetic column along the z direction.

In another variation of the example embodiment shown in FIG. 4 and FIG. 5, the transformer assembly 2 may include a plurality of transformer units 1 as shown in FIG. 1 and FIG. 2 arranged along the second direction (e.g., the z direction). That is, in the variation, the first magnetic column 30, the first column 40a, and the second column 40b may be respectively divided into two portions along the z direction, and each portion is connected to the base plate 10 and the cover plate 20 of each transformer unit 1 defining the transformer assembly 2.

Further, an air gap may be provided between upper and lower portions of the first magnetic column 30 along the z direction. Similarly, an air gap may be provided between upper and lower portions of the first column 40a and the second column 40b along the z direction.

In some example embodiments, positions of the air gaps in each transformer unit 1 of the transformer assembly 2 may be the same or different.

In another variation of the example embodiment shown in FIG. 4 and FIG. 5, the transformer assembly 2 may include two transformer units 1 arranged along the z direction, where a structure of one of the two transformer units 1 is shown in FIG. 2, and a structure of the other of the two transformer units 1 is shown in FIG. 3.

From above, with the example embodiments, a plurality of transformer units 1 with a “multi-to-one” structure are integrated, thus further improving efficiency of the transformer, and reducing an overall size and manufacturing costs of the transformer assembly. Specifically, the “multi-to-one” structure means that multiple primary windings 60 correspond to a same secondary winding 50 within a single transformer unit 1.

Further, each transformer unit 1 in the transformer assembly 2 includes the plurality of primary windings 60 integrated therein, and the number of the secondary windings 50 is significantly smaller than the number of the primary windings 60, which means that an increase in the number of the primary windings 60 in the transformer assembly 2 will not cause an increase in the number of the secondary windings 50, and thus will not be limited by factors such as losses, costs, and manufacturing difficulty. Therefore, in an application scenario of a TLVR circuit, the transformer assembly 2 provided in an example embodiment of the present invention can better meet the requirements of a quick response of the TLVR circuit with a smaller size.

FIG. 6 is a schematic diagram of a transformer unit 3 according to an example embodiment of the present invention, and FIG. 7 is an exploded view of the transformer unit 3 shown in FIG. 6. Differences between the transformer unit 3 and the example embodiment shown in FIG. 1 and FIG. 2 are mainly described here.

Specifically, referring to FIG. 6 and FIG. 7, different from the example embodiment shown in FIG. 1 and FIG. 2, for the transformer unit 3 in the present example embodiment, on the plane defined by the x direction and the y direction (e.g., the first plane), the cross-sections of the base plate 10 and the cover plate 20 are T-shaped structures with the same or substantially the same areas. In practical applications, those skilled in the art can adjust shapes of the base plate 10 and the cover plate 20 as needed, for example, a triangle or a circle.

Further, referring to FIG. 7, different from the transformer unit 1 in the example embodiment shown in FIG. 1 and FIG. 2, in the transformer unit 3 in the present example embodiment, n=3. That is, one first magnetic column 30 and three second magnetic columns 40 are provided between the base plate 10 and the cover plate 20. For the convenience of distinction, the three second magnetic columns 40 are respectively denoted as a first column 40a, a second column 40b, and a third column 40c.

Further, in the first plane parallel or substantially parallel to the base plate 10, that is, in a plane defined by the x direction and the y direction, the first column 40a, the second column 40b, and the third column 40c are arranged around the first magnetic column 30. Further, referring to FIG. 7, the first column 40a, the second column 40b, and the third column 40c surround the first magnetic column 30 in the first plane to define a partially closed structure.

Further, a projection of the first magnetic column 30 on the first plane is disposed in a region enclosed by projections of the first column 40a, the second column 40b, and the third column 40c on the first plane.

Further, the region enclosed by the projections of the first column 40a, the second column 40b, and the third column 40c on the first plane is T-shaped, and the projection of the first magnetic column 30 on the first plane is disposed at an intersection of a horizontal side and a vertical side of the T-shaped structure. For example, the first column 40a and the second column 40b may be arranged along the first direction (e.g., the x direction), and a line connecting the first column 40a and the second column 40b defines and functions as the horizontal side of the T-shaped structure. Further, the first magnetic column 30 is disposed at a center of the line connecting the first column 40a and the second column 40b. Further, a direction of the third column 40c pointing to the first magnetic column 30 may be parallel or substantially parallel to the y direction, and a line connecting the third column 40c and the first magnetic column 30 defines and functions as the vertical side of the T-shaped structure.

Further, a distance from each of the plurality of second magnetic columns 40 to the first magnetic column 30 may be equal or substantially equal. For example, referring to FIG. 7, the distances from the first column 40a, the second column 40b, and the third column 40c to the first magnetic column 30 are equal or substantially equal. In some example embodiments, being substantially equal may mean that an error of the distance from each second magnetic column 40 to the first magnetic column 30 is within a preset tolerance range which refers to a tolerance range of size. The error may be caused by an assembly process error during a manufacturing process.

Further, on the plane defined by the x direction and the y direction, cross-sections of the first magnetic column 30, the first column 40a, the second column 40b, and the third column 40c may all be rectangular or substantially rectangular, but are not limited thereto, and may alternatively be circular, substantially circular, elliptical, or substantially elliptical.

Further, in some example embodiments, the number of the primary windings 60 may be 3. The three primary windings 60 are respectively wound around the first column 40a, the second column 40b, and the third column 40c.

Further, the projections of the primary windings 60 on the first plane may not overlap. For example, referring to FIG. 6 and FIG. 7, the projections of the three primary windings 60 on the first plane (e.g., the base plate 10 or the cover plate 20) do not overlap.

Further, for each of the first magnetic column 30 and the plurality of second magnetic columns 40, an air gap (not shown) may be provided on the magnetic column to prevent the transformer unit 3 from generating magnetic saturation during operation. In some example embodiments, the air gap may be provided at any position of the magnetic column.

Referring to FIG. 7, an air gap may be provided between upper and lower portions of the first magnetic column 30 along the z direction. Similarly, air gaps may be provided between upper and lower portions of the first column 40a, the second column 40b and the third column 40c along the z direction, respectively.

In some example embodiments, referring to FIG. 7, for example, the upper and lower portions of the magnetic columns may be bonded together using glue with glass beads to provide an air gap in the middle of each magnetic column.

In some example embodiments, there may be an air gap between the magnetic column and the base plate 10 and/or the cover plate 20. For example, the air gap may be provided at a joint between the first magnetic column 30 and the cover plate 20, at a joint between the first magnetic column 30 and the base plate 20, at a joint between each second magnetic column 40 and the cover plate 20, and at a joint between each second magnetic column 40 and the base plate 10.

Further, referring to FIG. 6 and FIG. 7, different from the transformer unit 1 described in the example embodiment shown in FIG. 1, for the transformer unit 3 described in the present example embodiment, a conductive strip 603 used for each primary winding 60 surrounds the corresponding second magnetic column 40 in the first plane to provide a structure that exposes a surface of each second magnetic column 40 that faces away from the first magnetic column 30. In other words, in the present example embodiment, the surface of each second magnetic column 40 that faces away from the first magnetic column 30 is directly exposed to the outside, which improves heat dissipation effects of the transformer unit 3.

Further, the conductive strip 503 may surround at least three quarters of an outer circumference of the first magnetic column 30 in the first plane. For example, referring to FIG. 7, the conductive strip 503 almost completely surrounds the first magnetic column 30 in the first plane, and retains a small gap at the starting end and the ending end of the winding. The differences between the transformer unit 3 and the transformer unit 1 further lie in that the secondary winding 50 can also include a wing portion 504 extending outward from the transformer unit 3 (e.g., extending from the starting end and the ending end of the conductive strip 503 in an opposite direction of the z direction shown in the figures). The wing portion 504 is used to provide a current input terminal and a current output terminal at the starting end and the ending end, respectively.

Similarly, each primary winding 60 may further include a wing portion 604 extending outward from the transformer unit 3 (e.g., extending from the starting end and the ending end of the conductive strip 603 in the opposite direction of the z direction shown in the figures). The wing portion 504 is used to provide a current input terminal and a current output terminal at the starting end and the ending end, respectively.

While defining and functioning as an electrical connection end, any of the wing portions 504 and 604 can also support the transformer unit 3. Further, the transformer unit 3 is arranged on a circuit board such that the wing portion is welded to the circuit board. In this configuration, there is a non-zero gap between the base plate 10 of the transformer unit 3 and the circuit board, which can be used for other electronic components to be installed on the circuit board. Therefore, the design of the wing portion can, on one hand, support and electrically connect the transformer unit 3, and can, on the other hand, allow other electronic components to be installed on the circuit board under the transformer unit 3, thus providing better heat dissipation effects, and providing a maximized installation space for other electronic components that need to be installed on the circuit board.

In the present example embodiment, three non-overlapping primary windings 60 are arranged in the same plane, and the secondary winding 50 is arranged among the three primary windings 60. Therefore, the size of the transformer unit 3 is further reduced, thus further reducing costs, and improving the efficiency while maintaining the overall miniaturization of the device.

In a variation of the example embodiment shown in FIG. 7, the region enclosed by the projections of the first column 40a, the second column 40b, and the third column 40c on the first plane may be triangular or substantially triangular, and the first magnetic column 30 is disposed inside the triangular or substantially triangular projection on the first plane. In other words, the first column 40a, the second column 40b, and the third column 40c define a closed structure around the first magnetic column 30 in the first plane.

Specifically, the first column 40a, the second column 40b, and the third column 40c may define a closed triangle in the first plane (e.g., a plane perpendicular or substantially perpendicular to the z direction), and the first magnetic column 30 may be disposed at a center of the triangle.

Further, a distance between each of the plurality of second magnetic columns 40 and the first magnetic column 30 may be equal or substantially equal.

In some example embodiments, the triangle defined by the three second magnetic columns 40 may be, for example, an isosceles triangle, an equilateral triangle, or an arbitrary triangle.

In another variation of the example embodiment shown in FIG. 7, the transformer unit 3 may also differ from the transformer unit 1 in that n=4. That is, one first magnetic column 30 and four second magnetic columns 40 are provided between the base plate 10 and the cover plate 20, which are respectively denoted as a first column 40a, a second column 40b, a third column 40c, and a fourth column (not shown).

Further, in the first plane parallel or substantially parallel to the base plate 10, that is, in a plane defined by the x direction and the y direction, the first column 40a, the second column 40b, the third column 40c, and the fourth column are arranged around the first magnetic column 30.

Further, a projection of the first magnetic column 30 in the first plane is disposed in a region enclosed by projections of the first column 40a, the second column 40b, the third column 40c, and the fourth column on the first plane.

Further, a region surrounded by the projections of the first column 40a, the second column 40b, the third column 40c, and the fourth column on the first plane may be cross-shaped, and the first magnetic column 30 is disposed at an intersection of the cross-shaped projection on the first plane. Specifically, the first column 40a and the second column 40b may be arranged along the first direction (e.g., the x direction), the third column 40c and the fourth column may be arranged along the y direction, a line connecting the first column 40a and the second column 40b and a line connecting the third column 40c and the fourth column have an intersection, and the first magnetic column 30 is disposed at the intersection.

Further, distances from the first column 40a, the second column 40b, the third column 40c, and the fourth column to the first magnetic column 30 are equal or substantially equal. In some example embodiments, being substantially equal means that an error of the distance from each second magnetic column 40 to the first magnetic column 30 is within a preset tolerance range which refers to a tolerance range of size.

In some example embodiments, a region enclosed by projections of the four second magnetic columns 40 on the first plane may be a rectangle, and the projection of the first magnetic column 30 on the first plane may be disposed at a center of the rectangle.

In another variation of the example embodiment shown in FIG. 7, the first magnetic column 30, the first column 40a, the second column 40b, the third column 40c, and the fourth column included in the transformer unit 3 can each be an entirety, and are respectively disposed on the base plate 10.

Further, for each of the first magnetic column 30, the first column 40a, the second column 40b, the third column 40c, and the fourth column, an air gap may be provided between the magnetic column and the cover plate 20.

In another variation of the example embodiment shown in FIG. 7, the first magnetic column 30, the first column 40a, the second column 40b, the third column 40c, and the fourth column included in the transformer unit 3 can each be an entirety, and are respectively disposed on the cover plate 20.

Further, for each of the first magnetic column 30, the first column 40a, the second column 40b, the third column 40c, and the fourth column, an air gap may be provided between the magnetic column and the base plate 10.

FIG. 8 is a schematic diagram of a transformer unit 4 according to an example embodiment of the present invention, and FIG. 9 is an exploded view of the transformer unit 4 shown in FIG. 8. Differences between the transformer unit 4 and the transformer unit 1 are mainly described here.

Specifically, referring to FIG. 8 and FIG. 9, different from the transformer unit 1, in the transformer unit 4 in the example embodiment, the base plate 10, the cover plate 20, the first magnetic column 30, and the plurality of second magnetic columns 40 are an integral one-piece magnetic core.

The example embodiment in FIG. 8 and FIG. 9 is illustrated by taking n=2 as an example. Specifically, the transformer unit 4 includes a base plate 10 and a cover plate 20 arranged along a height direction (the z direction in the figures), and one first magnetic column 30 and two second magnetic columns 40 are arranged between the base plate 10 and the cover plate 20. For the convenience of distinction, the two second magnetic columns 40 are respectively denoted as a first column 40a and a second column 40b.

Further, the base plate 10, the cover plate 20, the first magnetic column 30, the first column 40a, and the second column 40b are integrally provided.

Further, there may be an air gap 400 on the first column 40a and the second column 40b. In some example embodiments, air gaps 400 may be provided at any position of the plurality of second magnetic columns 40. In the example embodiment shown in FIG. 9, the air gaps 400 are provided at the middle of the first column 40a and the second column 40b along the z direction.

Further, still referring to FIG. 9, different from the transformer unit 1, in the transformer unit 4 in the present example embodiment, the secondary winding 50 may include a main body 501, and the main body 501 may include a notch 502 on at least one side. Similarly, each of the plurality of primary windings 60 may include a main body 601 that includes a notch 602.

Further, the first magnetic column 30 extends from the notch 502 into the corresponding main body 501 in the first plane. For example, the main body 501 may be formed by winding a conductive strip 503 into a cylindrical shape and includes a notch 502 on at least one side in the first plane. A hollow portion of the cylindrical shape is used to accommodate the first magnetic column 30.

Similarly, the first column 40a and the second column 40b extend from the notches 602 into the corresponding main bodies 601 in the first plane, respectively. For example, the main bodies 601 may be formed by winding conductive strips 603 into cylindrical shapes, and each main body 601 includes a notch 602 on at least one side in the first plane. Hollow portions of the cylindrical shapes are used to accommodate the first column 40a and the second column 40b, respectively.

Further, in the plane defined by the x direction and the y direction (e.g., the first plane), an orientation of the notch 502 on the main body 501 may be the same or substantially the same as an orientation of the two notches 602 on the two main bodies 601. For example, in FIG. 9, the notch 502 and the notches 602 are both provided below the respective windings along the y direction according to the perspective of FIG. 9. However, it is not limited to this, and the orientation of at least one of the notches may be different from the orientation of other notches, which, for example, may be adjusted according to requirements of the circuit board to which the transformer unit 4 is applied. For example, the orientation of the notch 602 on the main body 601 corresponding to the first column 40a is the same or substantially the same as the orientation of the notch 602 on the main body 601 corresponding to the second column 40b, but is different from the orientation of the notch 502 on the main body 501 corresponding to the first magnetic column 30.

In some example embodiments, a device including the transformer unit 4 may include multiple Printed Circuit Boards (PCBs). By making the multiple notches of the transformer unit 4 face different directions, the primary windings 60 and the secondary winding 50 can be coupled to different PCBs to comply with electrical connection requirements of the device designed with multiple PCBs. For example, the notch 502 is arranged in the y direction, and the two notches 602 are arranged in an opposite direction of the y direction. The transformer unit 4 may be arranged between two PCBs spaced apart in upper and lower directions along the y direction, the secondary winding 50 is welded to the upper PCB, and the two primary windings 60 are welded to the lower PCB.

Further, the conductive strip 503 surrounds at least three quarters of an outer circumference of the first magnetic column 30 in the first plane. For example, referring to FIG. 9, the conductive strip 503 almost surrounds three sides of the first magnetic column 30 in the first plane, and no longer bends toward each other along the first plane at a starting end and an ending end of the winding (as shown in FIG. 2), so as to provide more spaces to form the notch 502.

Similarly, the two conductive strips 603 respectively surround at least three quarters of outer circumferences of the two corresponding second magnetic columns 40 in the first plane. For example, referring to FIG. 9, the two conductive strips 603 almost respectively surround the three sides of the first column 40a and the second column 40b in the first plane, and no longer bend toward each other along the first plane at starting ends and ending ends of the windings (as shown in FIG. 2), so as to provide more spaces to form the notches 602.

In a typical application scenario, when the transformer unit 4 shown in the present example embodiment is assembled, the base plate 10, the cover plate 20, the first magnetic column 30, and the plurality of second magnetic columns 40 may be an integral one-piece component, and the notch 502 of the secondary winding 50 extends downward in an opposite direction of the y direction from the perspective shown in FIG. 9, so that the first magnetic column 30 is inserted into the secondary winding 50 from the notch 502. Similarly, the primary winding 60 corresponding to the first column 40a extends downward in the opposite direction of the y direction from the perspective shown in FIG. 9 with the notch 602 facing downward, so that the first column 40a is inserted into the primary winding 60 from the notch 602. The primary winding 60 corresponding to the second column 40b extends downward in the opposite direction of the y direction from the perspective shown in FIG. 9 with the notch 602 facing downward, so that the second column 40b is inserted into the primary winding 60 from the notch 602. In this manner, the assembly of the transformer unit 4 is completed to obtain the structure shown in FIG. 8. Therefore, the assembly difficulty is further reduced by using the solution of the present example embodiment.

FIG. 10 is a schematic diagram of a transformer assembly 5 according to an example embodiment of the present invention, and FIG. 11 is an exploded diagram of the transformer assembly 5 shown in FIG. 10.

Specifically, the transformer assembly 5 may include a plurality of transformer units 4 described in the above example embodiment shown in FIG. 8 and FIG. 9.

FIG. 10 and FIG. 11 exemplarily illustrate the transformer assembly 5 including two transformer units 4 shown in FIG. 8 and FIG. 9. Specifically, the two transformer units 4 may be arranged side by side along the height direction (the z direction in the figures).

A specific structure of the transformer unit 4 is provided in the relevant description of the above example embodiment shown in FIG. 8 and FIG. 9, and is not repeated here.

Further, the plurality of transformer units 4 may be arranged along a second direction that is perpendicular or substantially perpendicular to the first plane. For example, referring to FIG. 10 and FIG. 11, the two transformer units 4 may be arranged along the z direction.

Further, central axes of the plurality of transformer units 4 along the second direction (e.g., the z direction) may overlap.

Further, a separation magnetic core 70 may be provided between adjacent transformer units 4.

Further, the separation magnetic core 70 may include a base plate 10 or a cover plate 20 shared by the adjacent transformer units 4. For example, referring to FIG. 11, the cover plate 20 of one of the adjacent transformer units 4 may define and function as the base plate 10 of the other of the adjacent transformer units 4. This further reduces a length of the transformer assembly 5 along the z direction to provide a compact design.

Further, the base plate 10, the cover plate 20, the first magnetic column 30, the plurality of second magnetic columns 40, and the separation magnetic core 70 of the plurality of transformer units 4 are integrally provided.

Further, air gaps 400 may be provided on the plurality of second magnetic columns 40. In some example embodiments, the air gaps 400 may be provided at any position of each second magnetic column 40. In practical applications, positions of the air gaps included in each transformer unit 4 of the transformer assembly 5 may be the same or different.

From above, by using the present example embodiment, a plurality of transformer units 4 with integrally provided integrated magnetic cores are integrated, thus further decreasing an overall size of the transformer assembly 5 and significantly reducing difficulty of production and assembly.

In a typical application scenario, referring to FIG. 12, the transformer assembly 2 described in the present example embodiment may be applied to a TLVR topology structure shown in FIG. 12, and the transformer assembly 2 includes a plurality of transformer units 1 arranged along the z direction. The TLVR topology structure using the transformer assembly 2 described in the present example embodiment can reduce the number of the secondary windings 50 by integrating a plurality of transformer units 1 with a “multi-to-one” structure, thus reducing the overall size and manufacturing costs of transformer assembly 2, significantly decreasing the overall size of the device, and improving efficiency of the transformer while ensuring miniaturization of the device.

Further, for a primary side of the transformer assembly 2, four primary windings 60 in two transformer units 1 are connected in parallel, where each primary winding 60 is connected to a power source Vin, and a corresponding switch K is used to control the conduction or disconnection of current.

Further, an inductor Lc may be connected in series to a secondary side of the transformer assembly 2. On the secondary side, the secondary windings 50 of the two transformer units 1 are respectively connected in series.

In a variation, the transformer assembly 5 shown in FIG. 10 and FIG. 11 can also be applied to the TLVR topology structure shown in FIG. 12, and the transformer assembly 5 may include a plurality of transformer units 4 arranged along the z direction. By using the TLVR topology structure of the transformer assembly 5 described in the present example embodiment, a plurality of transformer units 4 with an integrally provided integrated magnetic core are integrated, thus further decreasing the overall size of the transformer assembly 5, and significantly reducing difficulty of production and assembly of the entire device.

Further, the transformer assembly obtained by arranging any number of transformer units in FIGS. 1 to 3 and 6 to 9 along the z direction can be applied to the TLVR topology structure, so that the overall size of the device is further reduced while improving the efficiency.

Although specific example embodiments of the present invention have been described above, these example embodiments are not intended to limit the scope of the present invention, even where a single example embodiment is described with respect to specific features only. Examples of features provided in example embodiments of the present invention are intended to be illustrative but not limiting unless expressly stated otherwise. In specific implementations, technical features of one or more dependent claims may be combined with technical features of the independent claims, and may be combined in any appropriate manner rather than only through specific combinations listed in the claims.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A transformer unit, comprising:
a base plate and a cover plate;
a first magnetic column and a plurality of second magnetic columns between the base plate and the cover plate;
a secondary winding wound around the first magnetic column; and
a plurality of primary windings with a one-to-one correspondence with the plurality of second magnetic columns; wherein
the plurality of second magnetic columns are arranged around the first magnetic column in a first plane parallel or substantially parallel to the base plate; and
each of the plurality of primary windings is wound around a corresponding one of the plurality of second magnetic columns.

2. The transformer unit according to claim 1, wherein a distance between each of the plurality of second magnetic columns and the first magnetic column is equal or substantially equal.

3. The transformer unit according to claim 1, wherein projections of the plurality of primary windings on the first plane do not overlap with each other.

4. The transformer unit according to claim 1, wherein
the plurality of second magnetic columns include a first column and a second column arranged along a first direction;
the first magnetic column is positioned between the first column and the second column along the first direction; and
the first direction is parallel or substantially parallel to the first plane.

5. The transformer unit according to claim 1, wherein the plurality of second magnetic columns include a first column, a second column, and a third column that define a closed or partially closed structure around the first magnetic column in the first plane.

6. The transformer unit according to claim 5, wherein the first magnetic column is surrounded by the first column, the second column, and the third column, to define a ring.

7. The transformer unit according to claim 5, wherein
a region enclosed by projections of the first column, the second column, and the third column on the first plane has a T-shape; and
a projection of the first magnetic column on the first plane is provided at an intersection of a horizontal side and a vertical side of the T-shape.

8. The transformer unit according to claim 1, wherein
an air gap is provided on each of the first magnetic column and the plurality of second magnetic columns; and/or
an air gap is provided between each of the first magnetic column and the plurality of second magnetic columns and the base plate and/or the cover plate.

9. The transformer unit according to claim 1, wherein
each of the plurality of primary windings and the secondary winding includes a main body including a notch; and
each of the first magnetic column and the plurality of second magnetic columns extends from the notch into the corresponding main body in the first plane.

10. The transformer unit according to claim 9, wherein, in the first plane, an orientation of the notch on at least one of the main bodies is different from an orientation of the notches on the other main bodies.

11. The transformer unit according to claim 9, wherein the base plate, the cover plate, the first magnetic column, and the plurality of second magnetic columns are integrally provided.

12. The transformer unit according to claim 1, wherein each of the plurality of primary windings and the secondary winding includes a conductive strip wound in a cylindrical shape.

13. The transformer unit according to claim 12, wherein a thickness of the conductive strip of the plurality of primary windings is greater than a thickness of the conductive strip of the secondary winding.

14. The transformer unit according to claim 12, wherein the conductive strip of at least one of the first magnetic column and the plurality of second magnetic columns surrounds at least three quarters of an outer circumference of the respective magnetic columns in the first plane.

15. The transformer unit according to claim 1, wherein
each of the plurality of primary windings and the secondary winding includes a wing portion extending in a direction away from the transformer unit; and
the wing portion defines a support and an electrical connection end.

16. A transformer assembly, comprising:
a plurality of the transformer units according to claim 1; wherein
a separation magnetic core is provided between adjacent transformer units of the plurality of transformer units.

17. The transformer assembly according to claim 16, wherein the cover plate of one of the adjacent transformer units defines and functions as the base plate of another of the adjacent transformer units.

18. The transformer assembly according to claim 16, wherein the plurality of transformer units are arranged along a second direction perpendicular or substantially perpendicular to the first plane.

19. The transformer assembly according to claim 16, wherein a distance between each of the plurality of second magnetic columns and the first magnetic column is equal or substantially equal.

20. The transformer assembly according to claim 16, wherein projections of the plurality of primary windings on the first plane do not overlap with each other.
